(19) United States
(12) Patent Application Publication
(10) Pub. No.: US 2015/0135071 A1
(43) Pub. Date: May 14, 2015

(54) METHOD AND APPARATUS FOR DISTRIBUTION AND PRESENTATION OF AUDIO VISUAL DATA ENHANCEMENTS

(71) Applicant: Fox Digital Entertainment, Inc., Los Angeles, CA (US)

(72) Inventor: Matthew B. Glotzer, Scarsdale, NY (US)

(73) Assignee: Fox Digital Entertainment, Inc., Los Angeles, CA (US)

(21) Appl. No.: 14/538,767

(22) Filed: Nov. 11, 2014

Related U.S. Application Data
(60) Provisional application No. 61/903,328, filed on Nov. 12, 2013.

(51) Int. Cl. G06F 3/0484; G06F 21/10; H04L 29/06

(52) U.S. Cl. CPC G06F 3/04842; H04L 65/60; G06F 21/10
USPC 715/716

(57) ABSTRACT

A method, apparatus, article of manufacture, and system for the distribution and presentation of audio visual data enhancements is disclosed. Media content includes primary and secondary assets which can be presented and navigated therebetween, via widgets and asset maps that can be remotely authenticated and updated.

### CROSS-REFERENCE TO RELATED APPLICATIONS

This application claims benefit of U.S. Provisional Patent Application No. 61/903,328, entitled “METHOD AND APPARATUS FOR DISTRIBUTION AND PRESENTATION OF AUDIO VISUAL DATA ENHANCEMENTS,” by Matthew B. Glotzer, filed Nov. 12, 2013, which application is hereby incorporated by reference herein.

### BACKGROUND OF THE INVENTION

1. Field of the Invention

The present invention relates to systems and methods for presenting media content, and in particular to a system and method for presenting media content having audio and/or visual data enhancements.

2. Description of the Related Art

There have been a great many changes to the technology associated with the distribution and consumption of media content, and such changes have engendered changes in consumer behavior which have challenged the business of home entertainment. However, analogous technology trends can be used to assuage some of the difficulties with unauthorized dissemination and consumption of digital media content. Smartphones, connected televisions, and tablet computers are widespread and expected to become more so in the next 5 years. Increasingly, consumers are turning to such devices to consume media. Indeed, a typical consumer consumes more media (in terms of time) using mobile devices than using a television set.

With previous consumer electronic (CE) devices, the product remained pretty much as it was the moment it was shipped from the factory. Hence, the device capabilities did not fundamentally change and media paradigms evolved to account for this reality. For example, if a CE device was designed to play a certain format of media, the introduction of the same media with a new and incompatible file structure would require the consumer to purchase another CE device, rather than simply obtain an update permitting playback of the new media format. Even devices such as video game consoles (which permit some updates) did not allow significant updating capabilities. Conversely, current devices such as iPads, and connected TVs allow complete updating of firmware and software “in the field” (i.e. after purchase and installation).

These changes present challenges and opportunities. One of the challenges is to create media content that is easily usable with a broad class of intelligent and connected devices, automatically providing media content and services to the user when the mobile device is capable and adequately secure, and not providing such services when the device is incapable of adequately providing such content and services. This allows for more consistent engagement with consumers across all devices, as the media content is optimized for the particular device being used.

These changes also permit a number of opportunities, including the enrichment of the media content, offering the management or provision of such services “in the cloud,” thus allowing the content provider to add provide integrated access to additional content when available or remove content when required. They also permit revenue models that go beyond the usual rental and sell through channels, as further described below.

Product, revenue and retailer models can change as the content distribution and consumption can evolve as transmedia content development approaches are adopted. Currently, the product itself is an optical disc or electronic file having fixed bits that is provided only by retailers, and the content developer obtains revenue primarily from rental and content sales through retailers. This product is essentially a static product with little opportunity for enhancement over time, and the content developer has little or no opportunity, after the initial sale, to offer other content or services for additional revenue. In this model, revenue is primarily derived through retail sales of the media, and the “face” of the media is the retailer that serves the consumer.

The content distribution paradigm discussed herein permits periodic updates and enhancements (while also enhancing security to prevent unauthorized copying or access). Such updates make sell through more attractive, and also raise the possibility of the retailer and the content provider sharing access to the consumer for further sales and possible revenue sharing. As adoption progresses, the product itself turns to a publishing model analogous to software, and revenue models expand to include sell-through, micro-transactions and subscriptions (e.g. for additional or enhanced content), with the content developer having the option of a direct relationship with the consumer. In the long term, the product is distributed in a publishing model rather than a tangible sales of fixed bits, and the revenue model transitions to a blend of sell-through, micro-transactions (sales or dissemination of smaller bundles or rights or data) and subscriptions. In this model, the holder of the intellectual property rights to the information has options for a direct relationship with the end consumer.

Often, content of particularly high value because of follow on potential and tie ins is referred to as a “franchise.” Examples of a media content franchise include the movie “Planet of the Apes,” “Batman,” “Star Wars” and other such movies, which spawn the creation of follow on editions of the movie with different plots and/or characters, the creation of ancillary and related media (e.g. video games) or experiences (e.g. amusement parks and hotels).

First, the content distribution and consumption paradigm should provide a toolset that can be used over the entire life cycle of a franchise. In other words, when content is distributed for one portion of the franchise, that content should enable the user to access other franchise content as well as content related to those other assets.

Second, the product should not be consumed as a static experience, with the user simply sitting back and watching the movie. Instead, the product should be seen as a dynamic experience, placing the user on a path from which the user can explore other (and updateable) paths having new or updated content.

Third, the product should provide a wide variety of features, but unlike someone simply surfing the net on one screen while watching a movie on the other, the content should be presented in a way that is consistent across products (content or franchises), storefronts, and devices.

Fourth, the content distribution and consumption paradigm should permit content providers to interact and address consumers of content directly, while remaining supportive of retail partners.

Fifth, the content distribution and consumption paradigm should permit delivery of services relevant to the content that, and such services and content should be naturally resistant to unauthorized use.

The content distribution and consumption paradigm described herein meets these objectives.

### SUMMARY OF THE INVENTION

To address the requirements described above, the present invention discloses a method, apparatus, system, and article of manufacture for distributing media content. One embodiment is evidenced by a method of distributing content that comprises at least a portion of a primary media asset having a plurality of primary media asset segments, and at least a portion of a secondary media asset having a plurality of secondary media asset segments. The method comprises receiving information from a media program provider, the information readable by a processing device and the information comprises at least a portion of the primary media asset segments, a primary media asset index to at least some of the plurality of primary media asset segments, and at least two widgets, implemented by instructions executed by the processor, including a theater widget and a feed widget. The method further comprises retrieving, using the processor executing the theater widget, the plurality of primary media asset segments; providing, using the processor executing the theater widget, the plurality of primary media asset segments for presentation by a media player native to the processor according to an asset map having the primary media asset index; generating, using the processor executing the theater widget, a representation of each of the secondary media asset segments from a primary media asset index to at least some of the plurality of primary media asset segments according to the asset map, the representation of each secondary media asset segment for presentation concurrently and in context with the presentation of the plurality of primary media asset segments and retrieving and providing, using the feed widget and the asset map, a second media asset segment for presentation according to a user selection of the representation associated with the secondary media asset-segment.

Another embodiment is evidenced by an apparatus or system that comprises means for performing the aforementioned operations, one embodiment of which comprises a processor communicatively coupled to a memory storing instructions for performing such operations.

### BRIEF DESCRIPTION OF THE DRAWINGS

Referring now to the drawings in which like reference numbers represent corresponding parts throughout:

FIG. 1 is a diagram of a generalized information distribution system

FIG. 2 is a diagram illustrating a framework for the content distribution and consumption paradigm

FIG. 3 is a diagram illustrating additional details regarding the media, widget, and utility elements of the content distribution and consumption paradigm

FIG. 4 is a diagram of the relationship between the primary assets, secondary assets, and asset map of a franchise;

FIG. 5 is a diagram illustrating the presentation of primary and secondary assets using the content distribution and consumption paradigm;

FIG. 6 is a diagram illustrating exemplary operations that can be used to practice the content distribution and consumption paradigm;

FIG. 7 is a diagram illustrating one embodiment of how the plurality of primary asset segments may be retrieved;

FIG. 8 is a diagram illustrating one embodiment of a home page;

FIG. 9 is a diagram illustrating a interface to select other franchises or other feature films or primary assets in the franchise;

FIG. 10 is a diagram illustrating how secondary assets related to the currently selected primary asset can be directly accessed;

FIG. 11 is a diagram illustrating the presentation of the primary asset;

FIG. 12 is an enlarged view of the presented representations 1106 of the secondary asset on the timeline 1104;

FIG. 13 is a diagram illustrating the user interface at a point temporally occurring during the playback of the primary asset or movie;

FIG. 14 is a diagram illustrating a user interface shown based upon selection of one of the representations or highlighted text for playback of the secondary asset;

FIG. 15 is a diagram illustrating an exemplary embodiment of an interface having a control flower provided after selection of the share control;

FIG. 16 is a diagram illustrating an exemplary embodiment of an interface presented upon selection of a social network petal of the control flower;

FIG. 17 is a diagram illustrating one embodiment of a user interface a secondary asset that comprises a video of an interview of the director of the primary asset;

FIG. 18 is a diagram of one embodiment of the user interface produced by a script widget;

FIG. 19 shows one embodiment of how a dossier widget can render video, audio, image, text, or any of the other media;

FIG. 20 illustrates a user interface 2000 for a Q&A session permitting event; and

FIG. 21 is a diagram illustrating an exemplary computer system 2100 that could be used to implement elements of the content distribution and consumption paradigm.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

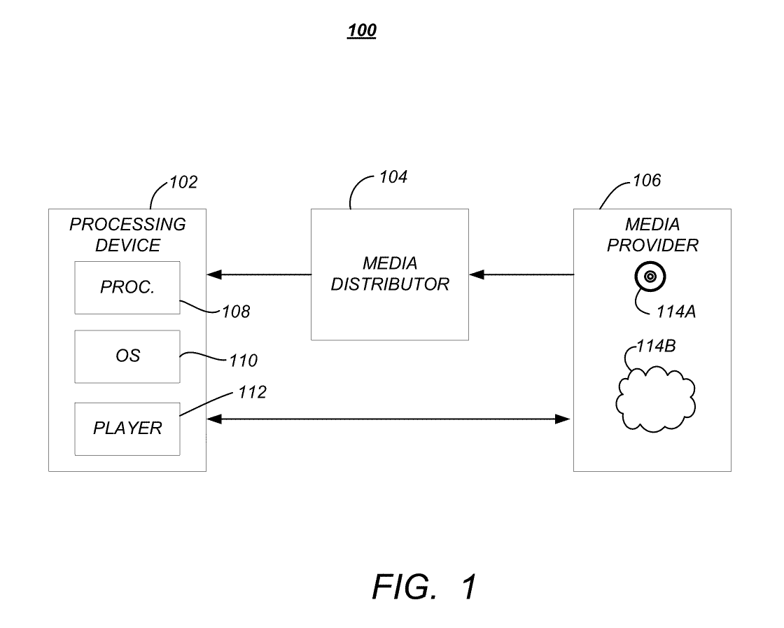

FIG. 1 is a diagram of a generalized information distribution system (IDS) 100. The IDS comprises a media provider 106 that can provide content to a user via a processing device 102. The content may be embodied on a tangible medium 114A or stored on a remote server accessible to the processing device 102, or “in the cloud” 114A. The content may be provided directly to the user for use in the processing device 102 or via a media distributor 104 such as a brick and mortar retailer or an on-line retailer such as ITUNES.

### Framework

### Architecture

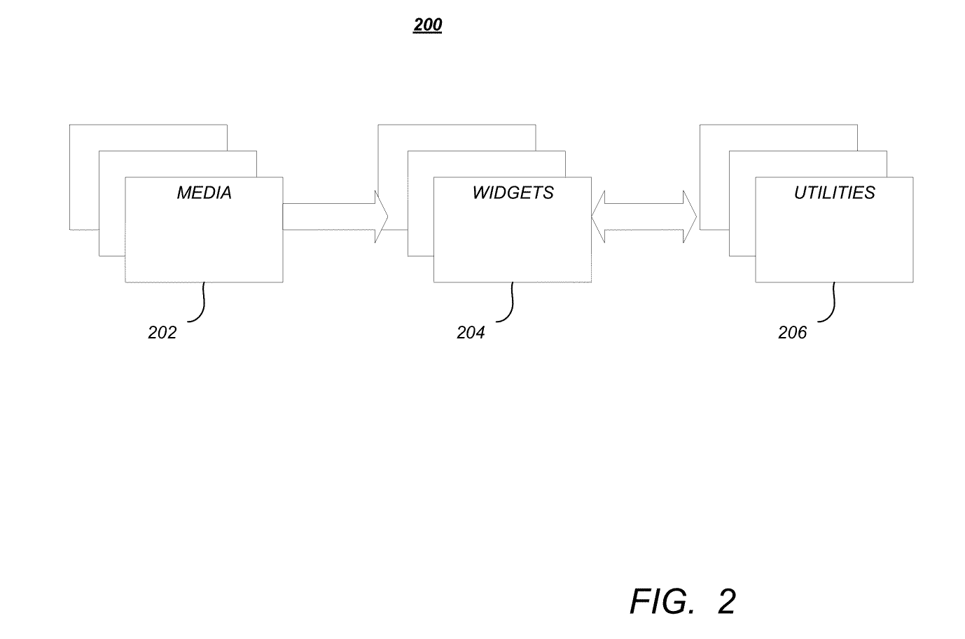

FIG. 2 is a diagram illustrating a framework for the content distribution and consumption paradigm (CDCP) 200. The framework weaves together three elements: media 202, widgets 204, and utilities 206. The media 202 and widgets 204 are the nouns and verbs, respectively, of the CDCP 200, while the utilities 206 offer functions that can be ubiquitously applied across the user experience at all levels and interfaces to permit communications with other services or devices.

Often, content of particularly high value because of follow on potential and tie ins is referred to as a “franchise.” Examples of a media content franchise include the movie “Planet of the Apes,” “Batman,” “Star Wars” and other such movies, which spawn the creation of follow on editions of the movie with different plots and/or characters, the creation of ancillary and related media (e.g. video games) or experiences (e.g. amusement parks and hotels).

### Elements

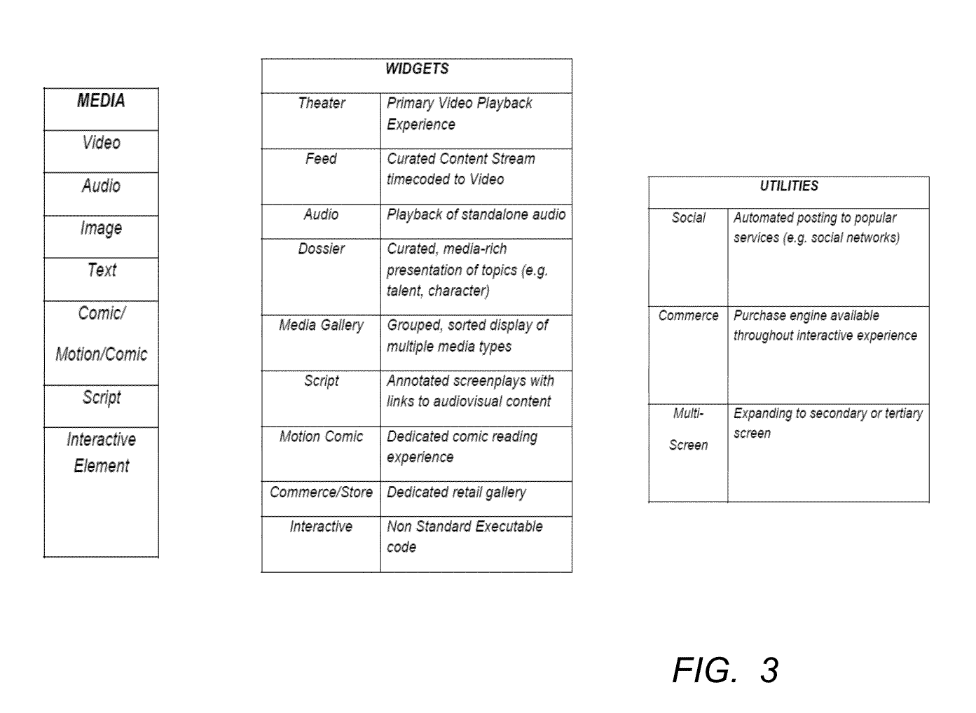

FIG. 3 is a diagram illustrating additional details regarding the media, widget, and utility elements of the CDCP 200.

### Media

The media represent the bill of lading, or each individual element of content which can be strung together with other elements of content using the widgets to provide user experience. Such media may include the feature video (e.g. the movie itself), animations, value added media (VAM) such as interviews with directors and actors, all as separate audio visual files. The media may also include still image files, audio files, text-based files, still or motion comics, scripts, graphics, and interactive elements.

Table I presents exemplary media types. Where possible, media types are defined according to widely accepted industry standards, so that all major device classes may utilize the media. Media may also be provided in multiple formats and in multiple versions (for example, MPEG2 and MPEG4 or different MPEG files, using different encoding characteristics (e.g. resolution)).

New media types are also defined. For example, scripts are different than generic text. Unlike generic text, script data is structured and to permit ties to the media content that was produced from the script. For example, the script may include links that when selected by the user, bring the user to the corresponding point in the movie, or to other relevant information.

TABLE I

| Media Type | File Type/Format |
|---|---|
| Video | MPEG2, MPEG4, AVC, H.264, H265/VCI/AVI, |
| | VP8, VP9, MPEG I, HEVC) |
| Audio | LPCM, MPEG 2 Layer 3 (MP3); AAC, |
| | AC3 DTS, DTS-MA, Dolby |
| | TrueHD, Dolby Atmos, DRA, DRA Extended |
| Image | JPEG, GIF, TIFF, PDF, PNG, BMP |
| Text | ASCII, UTF_8, UTF-32, RTF, DOC, DOCX, TXT |
| Comic/Motion | PDF, JPEG, GIF |
| Comic | |
| Script | Hypertext, Hyperlink |
| Interactive Element | Application Dependent |

### Widgets

Table II below illustrates exemplary widgets and interactive examples. Widgets, which represent “verbs” . . . the kind of activities that are used to string the media files together to provide the user experience. Importantly, widgets operate on these media assets and at least some of the widgets are operable across all processing devices 102 and operating systems 110, as well as some proprietary operating systems. Widgets 204 having application across all devices 102 are known as “core widgets.” Core widgets are authored so that they have wide application, for example using HTML5 or other programming language or structures that can operate across OS platforms and device classes. Proprietary widgets can be written in device or OS specific code (e.g. iOS or Android). Interactive examples can include trivia regarding the video or other media, user polls regarding the video or other media, and layered views, as defined in HEVC.

TABLE II

| Media Type | File Type/Format |
|---|---|
| Theater | Primary video playback experience |
| Feed | Curated content stream, indexed (e.g. time-coded) |
| | to video |
| Audio | Playback of stand-alone audio |
| Dossier | Curated, media rich presentation of topics |
| | (e.g. talent, character, location) |
| Media Gallery | Grouped/sorted display of multiple media types |
| Script | Annotated screenplays with links to audiovisual content |
| Motion Comic | Dedicated comic reading experience |
| Commerce/ | Dedicated retail gallery/commerce function |
| Store | |
| Interactive | Native, executable code |

The widgets 204 may include a theater widget, which strings together media files to present the primary video playback experience. Other widgets 204 include a feed widget, which includes a curated content stream, which is coded to be synchronized with the video presented by the theater widget. In one embodiment, this coding is based on time codes such as SMPTE (Society of Motion Picture & Television Engineers), and is used to synchronize the presentation of the primary video and other media types, as further described below.

The theater widget renders the video itself, the presentation of which consumes most of the display area. The feed widget provides for the presentation of a synchronized display of ancillary content related to what is concurrently presented in the theater widget. In one embodiment, the feed is not a pop-up, but rather displayed on a separate portion of the display from the media presented by the theater widget. The feed includes links to other media content that is relevant to the content presented by the theater widget, and the existence and temporal relationship of such other media content may be presented in a progress bar interface, as further discussed below. The user may navigate though the media program using the theater widget by usual means, but may also navigate to the other media content via the feed progress bar.

Synchronization between the media program presented by the theater widget and the other media identified by the feed can be accomplished using SMPTE time code information, and may include a time period within the underlying media program (for example, auxiliary media content may refer to something being depicted in the media program from 1:23:34 to 1:24:54 of the media program. A summary of the auxiliary content may be presented in a portion of the display, providing links that the user can select to play the auxiliary content and place the media program in the background. Such summaries can appear during the appropriate duration (e.g. 1:23:34 to 1:24:54) and disappear from the feed presentation thereafter.

Content presented by any of the widgets (including the feed widget) may be resident on a tangible medium (e.g. and optical disc) that is provided to the consumer by a retailer or by the content provider. Other content may not be provided in the tangible medium itself, but provided to the device after distribution of the medium via the Internet or other communication link, and may be provided directly by the content provide that provided the underlying content, or licensees of that content provider. Hence, additional content may be “in the cloud,” either retrieved for only temporary storage in the device when desired by the user, downloaded for indefinite storage on the user device for storage until further commands from the content provider delete the additional content, or downloaded for permanent storage. This permits the experience to be remotely updatable, not only in terms of auxiliary content, but the media program presented by the theater feed itself. This also permits the content provider to connect different editions or episodes of the media program. For example, if a consumer purchases an optical disk having the “Planet of the Apes II,” this feature can be used to provide a key for the consumer to obtain a copy of “Planet of the Apes III,” or a movie ticket to see “Planet of the Apes III,” a discount admission, or access to video games that use “Planet of the Apes” as a tapestry.

For example, a movie, as provided by the theater widget, may depict a scene having a number of birds, and the feed widget may provide a link to a specific version of the “angry birds” video game that is tied to the movie content. So as the user is watching the movie using the theater widget, the feed widget presents a link to the movie, the user has the ability to jump out of the movie at this point, and jump into playing the game, or to jump from playing the game to that particular period of time in the movie. Crosslinking between media content may also be provided. For example, game play of the video game may be affected by the fact that the user came to the video game having watched the movie or from the movie (e.g. video game features can be unlocked based upon viewing state information for the underlying movie or the viewing state can be modified by virtue of the user arriving at the movie from the video game. For example, the particular scene from the movie showing the number of birds may only be shown if approached from the video game or when the movie and the video game are consumed concurrently.

### Utilities

The utilities call application program interfaces (APIs) available from external services or devices. These can include APIs permitting automated posting and receiving updates to/from social networking services such as FACEBOOK, TWITTER, PINTEREST, TUMBLR, and REDDIT. For example, the user may select a single control to share with others the identity or content of the media program they are consuming, or they may comment, endorse, or express an opinion about the content.

They may also include commerce utilities that provide a purchase engine to buy products, including products that are depicted or referred to in the media content. They may also include a multi-screen utility that allows the user to move the experience to another screen or another device.

The presentation of links and commands that invoke the utilities 206 are ubiquitous throughout the viewing experience. That is, a control is provided allowing the user to invoke the utility, regardless of where they are in the viewing experience, as described further below. Also importantly, a minimum of user commands are required to invoke these utilities, preferably a single control, making the utility a user-tap away from the experience.

Typically, the utilities 206 require an application native to the device to call and application program interface (API) to the social network, commerce portal, or other device or display.

Multi-screen APIs include not only the ability to throw content that has begun on one screen to another screen, but also allows for functionality such as linked watching, wherein a user may throw their viewing experience to fiends at remote locations with devices of similar capability. The user throwing the viewing experience may continue to control the presentation of the experience (e.g. selection of auxiliary content or simply fast forwarding, pausing, or rewinding the underlying content).

### Element Relationships

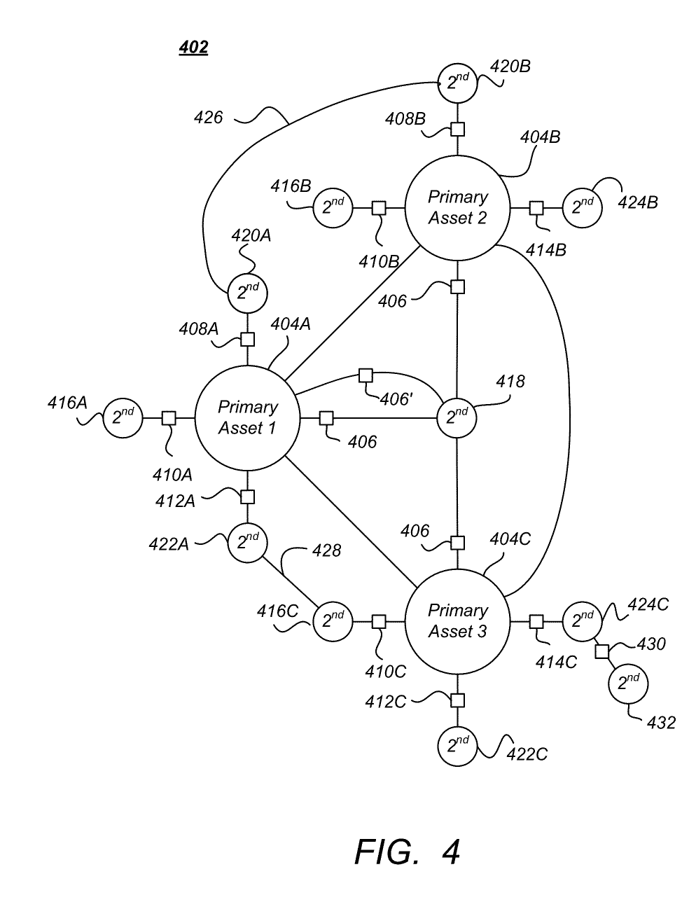

FIG. 4 is a diagram of the relationship between the primary assets 404A-404C of a franchise 402, the secondary assets 416A-416C, 420A-420B, 422A, 422C, 424B and 424C, and widgets 406, 406′, 408A, 408B, 410A-410C, 412A, 412C, 414B and 414C used to provide the secondary assets.

Typically, each of the primary assets 404A-404C (hereinafter alternatively referred to as primary assets 404 comprise a media program such as a movie. Hence, the franchise 402 may comprise a plurality of movies 404. The secondary assets 416A-416C, 420A-420B, 422A, 422C, 424B and 424C (hereinafter alternatively referred to as secondary assets (2^{nd}) comprise media other than the movie itself, and can include the audio, image, text, comic/motion comic/script, or interactive elements shown in FIG. 3 and discussed above. Widgets 406, 406′, 408A, 408B, 410A-410C, 412A, 412C, 414B and 414C (hereinafter collectively referred to as widgets 204′) can include the feed, audio, dossier, media gallery, script, motion comic, commerce, or interactive widgets shown in FIG. 3 and discussed above. The theater widget is not illustrated in FIG. 4, as it is common to all of the primary assets 404 and although it may indirectly provide access to the secondary assets (e.g., the theater widget may call a method or subroutine that invokes or executes the widget to access and use the secondary asset), the theater widget is not the primary means by which the secondary asset is presented. Rather, access to the secondary asset is provided by the associated feed widget 204′.

As shown in FIG. 4, access to a particular secondary asset may be provided via more than one widget. For example, access to widget 418 may be provided by widget 406 and second widget 406′. Second widget 406′ may be an entirely different widget, providing the user with a different secondary asset 418 experience, or may simply provide access to the second widget 418 in a way that is compatible with a different version of the secondary asset 418 (e.g. a lower resolution version or a version that complies with a different file or coding standard than the standard version). Likewise, a particular secondary asset may be made available via more than one primary asset. For example, in FIG. 4, secondary asset 418 is available via primary assets 1-2 (404A-404C). As a further example, if primary assets 404 are three different movies of the PLANET OF THE APES franchise, secondary asset 418 may refer to a video game that is appropriate for all three primary assets 404.

FIG. 4 also illustrates potential paths by which the user, using the processing device 102 and the CDCP 200, can navigate from the viewing of the one of the primary assets 404 to another primary asset 404 or to a secondary asset (2nd). Navigation may be provided either directly between primary assets 404 (e.g. menu commands described herein) or via secondary assets (e.g. navigation from primary asset 402B to primary asset 402C via secondary asset 418. Further, direct navigation from secondary asset to secondary asset (and not through a primary asset 404 or another secondary asset) may also be implemented, as shown by path 426 (illustrating a navigation pathway between secondary asset 420A associated with the primary asset 404A and a secondary asset 420B that is related to secondary asset 420A and associated with primary asset 404B. For example, secondary assets 420A and 420B may implement similar functionality, but differ in that they are intended for use only with their associated primary assets (e.g. primary assets 404A and 404B, respectively). Such may be the case if secondary asset 420A and 420B are both feed assets that provide a curated content stream that is indexed (e.g. timecoded to) the associated theater feed of each secondary asset's related primary asset (404A and 404B, respectively.

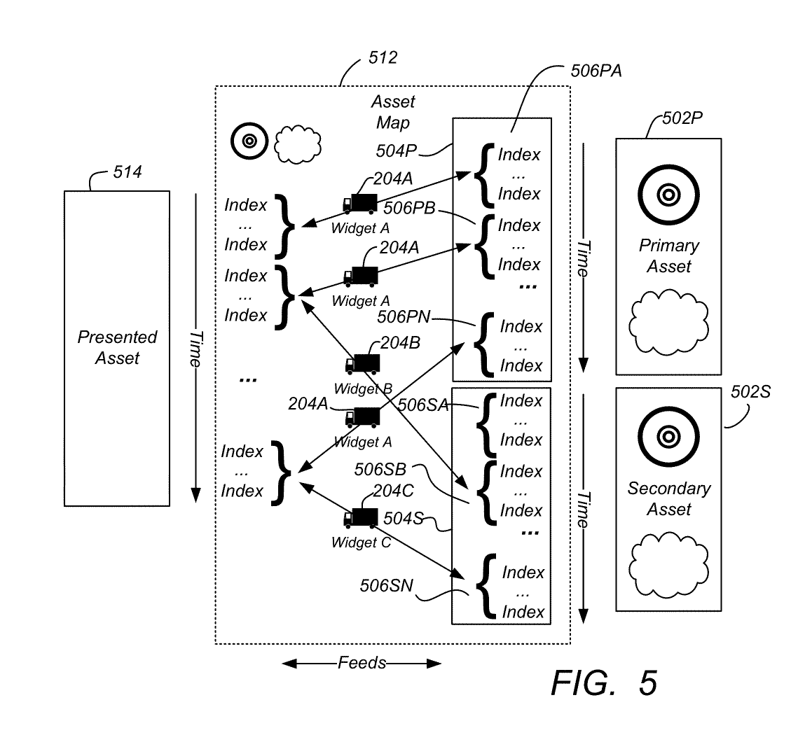

FIG. 5 is a diagram illustrating the presentation of primary and secondary assets using the CDCP 200. Primary asset 502P is typically movie or video that has a plurality of primary media asset segments. Typically, the primary asset 502B is temporally segmented (e.g. segmented into a plurality of time segments), and when all of the primary asset segments are assembled and presented in the proper order, this enables presentation of the movie program or video. Other segmentations are possible, however. The primary asset 502P may be segmented by content (e.g. by scene, analogous to the scene selection in DVDs), by coding or compression milestone or index (e.g. by I frame or other reference frame that does not require data from nearby frames for decoding or decompression) or simply by time (wherein the time segments are selected without regard to content or coding, for example the selection of segments 10 seconds long).

As illustrated in FIG. 5, the primary asset 502P is segmented to include segments 506PA-506PN, and each of the segments are associated with a unique index. In one embodiment, the index includes a SMPTE (Society of Motion Picture and Television Engineers) timecode, Manchester code, or analogous time code. The index may include a first index value to the temporal beginning of the segment and a second index value to the temporal end of the first segment (useful when the segments, taken together, do not represent the entire primary asset), or an index value to temporal beginning of the segment (where the segments, taken together, represent the entire primary asset).

As noted above, primary asset segments 506PA-506PN need not be contiguous. In other words, the segments defined in the primary asset may not span the entire temporal length of the asset. For example, the temporal portion of the primary asset 506P denoted in segment 506PB may not be defined as a segment of the primary asset 506P.

Similarly, secondary asset 502S is segmented to include segments 506SA-506SN, and each of the segments are associated with a unique index. The segmenting of the secondary asset 502S may or may not parallel that of the primary asset 502P. For example, where the segments of the primary asset 502P together represent the entire primary asset 502P, the segments of the secondary asset 502S may together represent less than the complete secondary asset 502S and vice versa.

The asset map 512 defines which primary asset segments 506P should be provided for display in which order, and which widgets 204 are to be used in such provision. In the illustrated embodiment primary asset segment 506PA is to be provided so as to be presented first, then primary asset segment 506PB, and ending in primary asset segment 506PN, with such provision provided by widget 204A, to create (at least partially), the presented asset 514. In one embodiment, widget 204A (which provides the primary asset or the movie to the processing device 102 for presentation) is the theater widget discussed above.

The definition of the widgets 204 to be used to retrieve and provide the primary asset segments 506P for presentation can be based on a number of factors including:

The Capability/Capacity of the Processing Device 102:

As described above, it is important that the processing device 102 be provided with the proper primary asset 502P in a way that is suitable for that processing device 102. Hence, one or more of the widgets 204, provide information about the processing device 102 to a remote entity or the processing device 102, and that remote entity or processing device may determine the suitable version of the primary asset 502P to provide and the suitable widget 204 to provide it. For example, if the processing device 102 is queried and found to be either compromised or implementing unsuitably rudimentary digital rights management (DRM), a low resolution version of the primary asset 502P may be provided by a widget 204 that is optimized for that presentation. Alternatively, the provided version of the primary asset 502P may be the same as a high resolution version, but the widget 204 used to provide the primary asset segments 506P may reduce the resolution of the segments 506P before providing them to the processing device for presentation.

The Authorization of the Processing Device/User:

As described above, it is important that the processing device 102 be provided with the primary asset segments 506P only if the processing device 102, widget 204 or user is authorized for such presentation. This can be indicated or verified by use of symmetric or asymmetric secret exchange, security certificates, or other means, thus not only assuring that the proper widget 204 is used for each particular primary asset 502P (or as discussed below, secondary asset 502S), but that the widget 204 and/or device itself is authorized.

The asset map 512 also defines which widgets 204 to be used to retrieve and provide the secondary asset segments 506P for presentation can be based on the same factors described above. For example, the asset map 502 defines that secondary asset segment 506SB is associated with primary asset segment 506PB, and that secondary asset segment 506SN is associated with secondary asset segment 506PN. Although not illustrated in the example in FIG. 5, either or both secondary assets 506SB and 506SN may also be associated with other primary assets 506P and a particular primary asset 506P may be associated with any number of secondary assets 506S including zero secondary assets 506S.

In one embodiment, one of the widgets 204 is uses the asset map 512 to provide data to the processing device 102 that presents data visually indicating to the user the temporal location where secondary asset segments 504S are located relative to the presented asset 514. This is further described below with respect to the user interface.

As illustrated in FIG. 5, the primary asset 502P may be embodied in a tangible media such as a CD, a DVD, a flash drive, or other means for storing data. That primary asset 502P may be provided to the user for use with the processing device 102 by distribution to retailers or directly to the user. The primary asset 502P may also be stored remotely (e.g. on a server communicatively coupled to the processing device 102 via the Internet or similar means), and provided to the user's processing device 102 either without compensation, or following payment by the user. The secondary asset 502S may be provided in the same way as the primary asset 502P, either separately, at the same time, or even on the same media or transmission as the primary asset 502P.

Further, different portions of the primary asset 502 may be provided by different means. For example, a first portion of the primary asset (e.g. a subset of the primary asset segments 506P), may be provided via tangible medium, with the remaining portions (remaining primary asset segments 506P) provided via the Internet or similar communication. In one embodiment, for example, the first portion is provided on a DVD free of charge, but the remaining portion of the primary asset 502 are provided via the Internet, following payment by the user. Further, the remaining portion(s) may be served to the processing device 102 for only temporary storage before presentation, thus rendering the tangible medium alone insufficient to view the entire media program, and protecting it from unauthorized viewing. The same partial provisioning technique can be used to protect the secondary asset 502S if desired.

Similarly, the asset map 512 may be provided on the same medium as the primary asset 502P, the secondary asset 502S, or may be obtained remotely, subject to approval or authorization. The asset map 512 may be partitioned into more than one asset map, one for each asset 502P and 502S, and a further asset map that maps the primary asset 502P to the secondary asset 502S, and different partitions may be provided according to whether the user is authorized to access those portions served by the asset map 512.

The asset map 512 may be allowed to be locally stored on the playback device or only temporary storage may be permitted. For example, selected embodiments that require the ability to present any portion of the primary asset 502P at all times (even when not coupled to a remote server) may permit at least short term storage of the asset map 512 and/or the primary asset 502P, while other embodiments that do not require the ability to present any portion of the primary asset 502P at all times (even when not communicatively coupled to the remote server) may not permit storage of the asset map by the processing device 102, instead keeping the asset map 512 secure at the remote server.

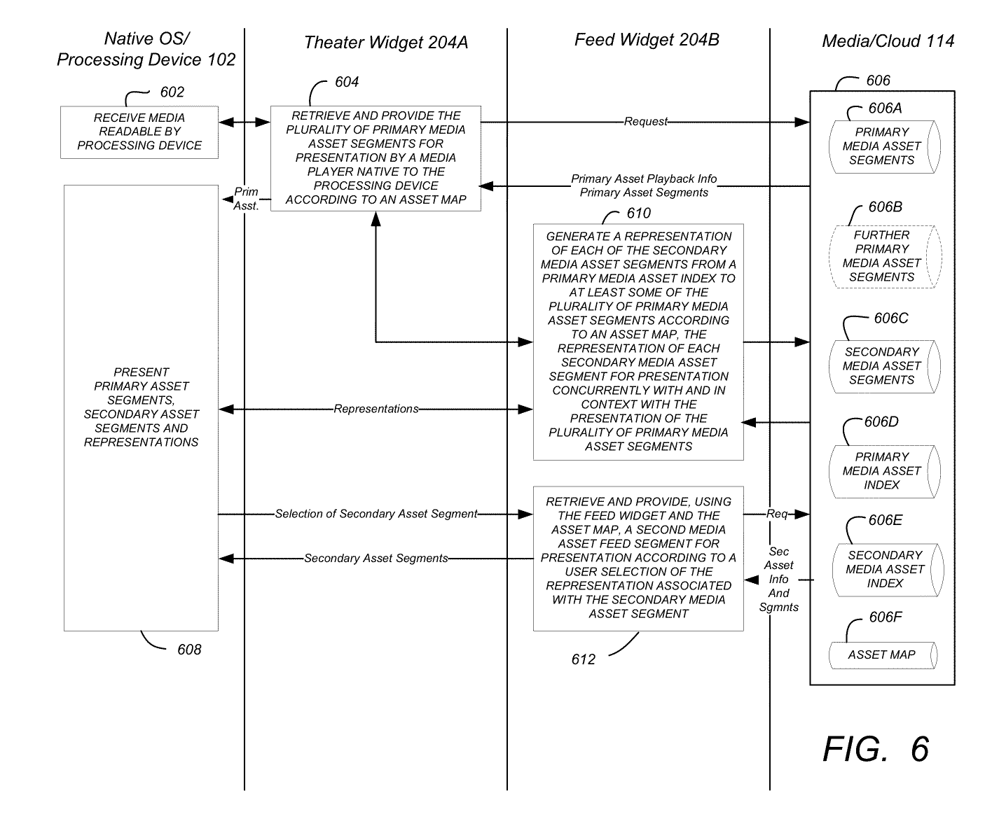

FIG. 6 is a diagram illustrating exemplary operations that can be used to practice the CDCP 200. In block 602, media that is readable by the processing device is received and provided to the processing device 102.

As described above, the primary asset 502P, secondary asset 502S and/or asset map 512 may be provided to the end user for use on the processing device 102 by electronic transmission via a communication medium such as the Internet, or can be provided in a tangible form, such as a DVD. For example, the primary asset 502P and asset map 512 for presenting the primary asset 502P may be provided in a retail outlet in the form of a DVD. This permits the recipient of the DVD to insert it into the processing device 102 (e.g. a computer or DVD player), and playback the primary asset without further communication with external entities. Selected secondary assets 502S and asset maps 512 for presenting those secondary assets 502S in conjunction with the primary asset 502P may also be provided on the distributed DVD, and may also be reproduced without the need for further communication with remote entities. Alternatively, the DVD may include the primary 502P and secondary 502S assets, but be encrypted so as to require the processing device 102 to obtain key(s) or other data to decrypt the primary 502P or secondary asset 502S. Or, the DVD may include only portions of the primary 502P and/or secondary asset 502S, with the remaining portions required for viewing the complete assets only available by communicating with a remote server. Finally, the DVD may also exclude the asset map(s) 512, hence requiring communication with the remote server for playback.

In block 604, the plurality of primary asset segments 506P are retrieved for presentation by the processing device 102 according to the asset map 512. In one embodiment, the primary asset segments 506P are retrieved and provided to a media player 112 native to the processing device 102 and it's operating system 112. In embodiments wherein the primary asset segments 506P are disposed on tangible media distributed to the user, the primary asset segments 506P are retrieved from that tangible media. Further, in embodiments wherein the primary asset segments 506P are stored remotely or “on the cloud,” those primary asset segments 506P are retrieved from the cloud. Also, in embodiments wherein a subset of the primary asset segments 506P are stored on the tangible media and the remainder on the cloud, they are retrieved from the tangible media and cloud according to the asset map 512.

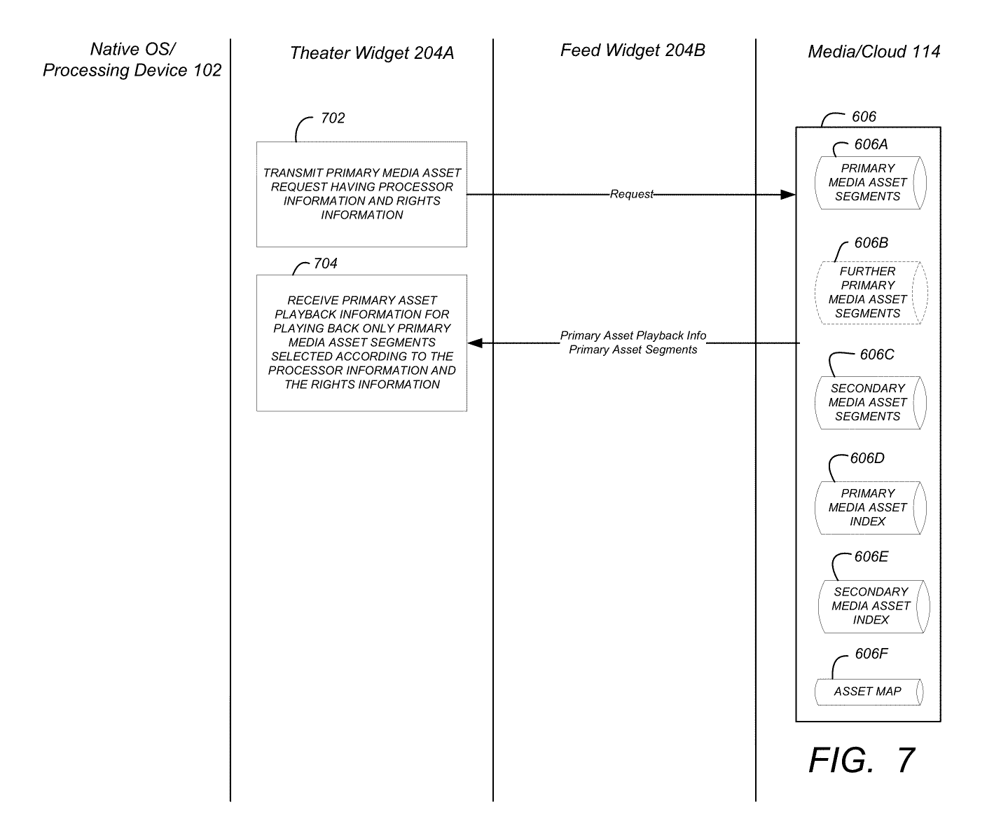

FIG. 7 is a diagram illustrating one embodiment of how the plurality of primary asset segments 506P may be retrieved. In block 702, a primary media asset request is transmitted to request access to the primary media asset 502P. In one embodiment, the request is transmitted by a widget 204A such as the theater widget. The request may include information regarding the processing device 102 such as the processor type, available memory or processing speed. This permits the widget 204 to retrieve the proper primary asset segments 506P that are appropriate for presentation by the processing device (e.g. the segments are of a resolution, frame size, and other parameters that the processing device 102 is capable of processing for adequate quality reproduction). The request may also include processing device 102 information regarding file types that are supported by the processing device (e.g. MPEG, MPEG-4, AVI), to assure that the primary asset segments 506P provided are of the proper file format. The request may also include the size/resolution of the display associated with the processing device 102. The request may also include playback rights information such as an identifier of the processing device 102 and/or the processor 108 used in that processing device. The request may also include the user's identity, credit card, or other payment information by which payment or compensation is made for access to the primary asset segments 506P. The request may also include cryptographic information such as a digital certificate, secret, or other data, by which the identity of the processing device 102 can be ascertained and authenticated, and which can be used to later transmit cryptographic information to the processing device 102 (e.g. a shared secret or public/private key). In response, the theater widget 204B receives playback information for the primary asset segments 506P, and the primary asset segments themselves 506P. The playback information may include the asset map 112, keys to decrypt primary asset segments 506P that are encrypted, a signed digital certificate from the media/cloud as appropriate. The provided asset map 112, may include the primary asset index 504P.

Returning to FIG. 6, the feed widget 204B generates a representation of each of the secondary asset segments 506S for presentation concurrent and in context with the primary asset 502P as further described below. This involves using the asset map 512, which mapping the secondary asset segments 506S to associated primary asset segments 506P. The result is a presentation of the primary asset 502P and a representation of the secondary asset segments 506S on that presentation in context. One contextual example is to present the primary asset with a progress bar that indicates the temporal location of the portion of the primary asset 506P being currently reproduced, and to include user-selectable controls indicating the temporal location of the secondary asset segments 506S on that progress bar as further described above. Another contextual example is to present the primary asset with links disposed in the display (e.g. text that appears when hovered over) that indicate a related secondary asset segment 506S. Selection of the user link or user selectable control invokes the widget 204 associated with that secondary asset segment 506S (as defined in the asset map 512), thus presenting the secondary asset segment 506S itself to the user.

In bock 608, the primary asset segments 506P, secondary asset segments 506S, and the representations of the secondary asset segments 506S are provided to the native (e.g.) media player 112 for presentation to the user, as shown in block 608. A selection of a secondary asset segment (e.g. by user manipulation or selection of a control labeled by the secondary asset representations described above) sends a command to the feed widget 204B. Such selection invokes the feed widget 204B to retrieve and provide the selected secondary asset segment (for example 506SB) for presentation using the asset map 112.

In one embodiment, the primary asset 502P comprises one or more triggering events that can be used to conditionally unlock or provide access to one or more of the secondary asset segments 506S. Such events and the mapping to the secondary asset segments 506S can be identified in the asset map 512 (e.g. the primary asset index 506P, the secondary asset index 506S, or an index mapping the primary asset index 504P to the secondary asset index 504S). The presentation or other consumption of the second asset segment 506S can be unlocked so as to be performed only on a condition that the necessary triggering event (as defined by the asset map 112) has occurred. For example, a secondary asset segment 506S may comprise a portion of a video game that is “unlocked” when an identified segment or segments of the primary asset 502P such as a movie has been viewed.

Similarly, the secondary asset 502S may comprise one or more triggering events that can be used to conditionally unlock or provide access to one r more of the primary asset segments 506P. Such events and the mapping to the primary asset segments 506P can be identified in the asset map 512, and the presentation or other consumption of the primary asset segment 506P can be unlocked so as to be performed only on a condition that the necessary triggering event has occurred. For example, the primary asset segment 506P may comprise a portion of a movie that is “unlocked” for presentation and viewing when an identified segment or segments of a secondary asset 502S such as a video game is played or a goal achieved during such play. The asset map 512 may also define multiple triggering events that must occur before the secondary asset segments 506S (or, conversely, the primary asset segments 506P) can be consumed.

### User Interface

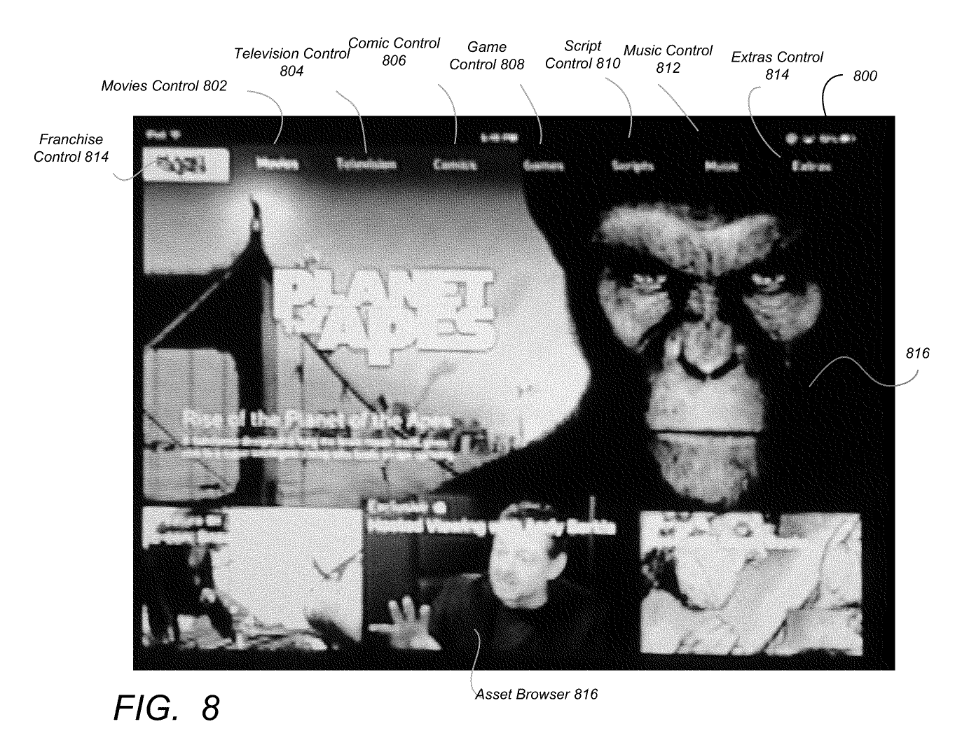

FIG. 8 is a diagram illustrating one embodiment of a home page 800. In this embodiment, the home page 800 is a franchise level home page . . . that is, the home page 800 provides a portal into a franchise 400 of primary assets 502P such as movies. In the illustrated example, the franchise is the “Planet of the Apes” franchise, and encompasses all of the movies in the Planet of the Apes series of movies including: Planet of the Apes (1968); Beneath the Planet of the Apes (1970), Escape from the Planet of the Apes (1971); Conquest of the Planet of the Apes (1972); Battle for the Planet of the Apes (1973); Planet of the Apes (TV series); Return to the Planet of the Apes, a 1975 American animated television series; Planet of the Apes (2001 film), a remake of the 1968 film; Rise of the Planet of the Apes (2011 film), a reboot of the series; Dawn of the Planet of the Apes (2014 film), a sequel to the 2011 reboot of the series. The media franchise may also include other media types including publications (comics, novels, and sequels).

In the illustrate embodiment of the home page, the user may navigate directly to different assets including primary assets (via movie control 802), and secondary assets using controls 804-814. For example, television control 804 can be used to access a television series or program secondary asset, comic control 806 can be used to access a comic book or motion comic secondary asset, game control 808 can be used to access a video game secondary asset, script control 810 can be used to access a script secondary asset, music control 812 can be used to select a music secondary asset, and extras control 814 can be used to access other secondary assets.

Below the main screen is a highlight bar or asset browser 816, having a scrollable (e.g. by swiping) series of images, each representing secondary content related to the media franchise 400 or in particular, the secondary assets related to the primary asset shown in the main display 818 (otherwise referred to as the home primary asset. In one embodiment, newly available media content is illustrated or highlighted in this lower portion of the home screens.

As described above, the user may buy into the franchise 400 by the purchase of any one of the feature films or primary assets 404 in the franchise, or may be required to buy 2 or more feature films to gain access to the franchise 400. In another embodiment, the user may enter into the franchise model by being provided the media before the release of the feature film . . . for example, by mailing or otherwise distributing an optical disc or other tangible/intangible media before the release of the movie itself. This permits use of the media as advance marketing. Additional media content . . . even the feature film or primary asset 404 itself can be provided afterwards, and in embodiments wherein the contents of the original optical disc have been copied to the device, even without the optical disc itself. Tickets to view the feature film in a theater may also be available using the optical disc. The interface may also provide a link to another franchise 400.

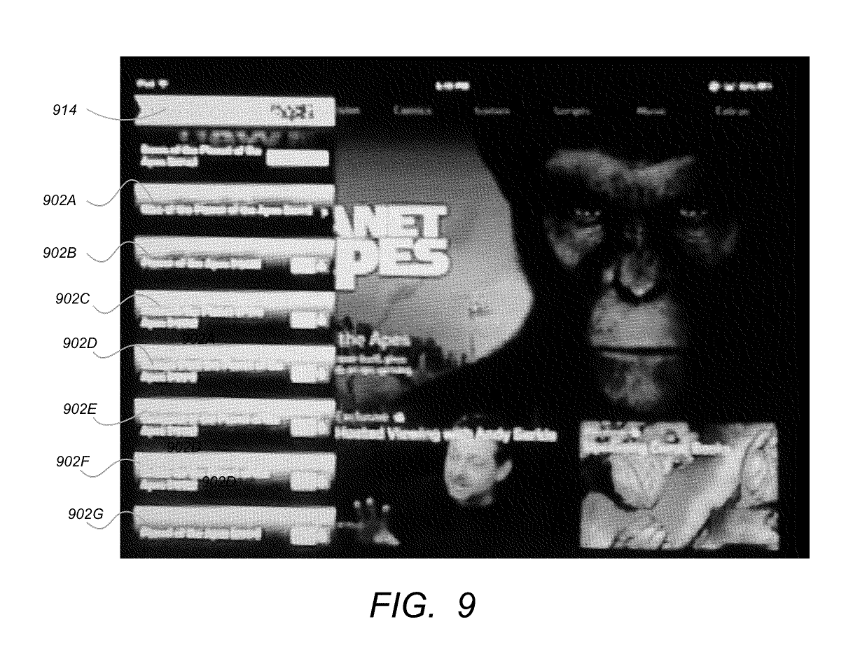

FIG. 9 is a diagram illustrating a interface to select other franchises 400 or other feature films or primary assets 404 in the franchise 400. For example, selection of the franchise control 814 may opens up a ribbon that can be used to select other franchises and/or other feature films or primary assets 402 in the franchise 400.

Selecting the franchise control element 914 of the ribbon associated with the other feature films produces an interface by which the user may view the related feature film (e.g. by selection of one of the controls 902A-902G, with each control providing access to one of the primary assets 404 in the franchise 400. Listed assets may include primary assets 404 that have yet to be released, thus allowing the user to preview new assets, potentially by viewing secondary assets related to the primary asset 404 such as film clips or other promotional material. Primary assets as yet unreleased may also be linked to from secondary assets related to primary assets that are already released. For example, if “Escape from Planet of the Apes” has been released and includes a secondary asset video game, that video game secondary asset may provide a link to the as yet unreleased future Planet of the Apes movie.

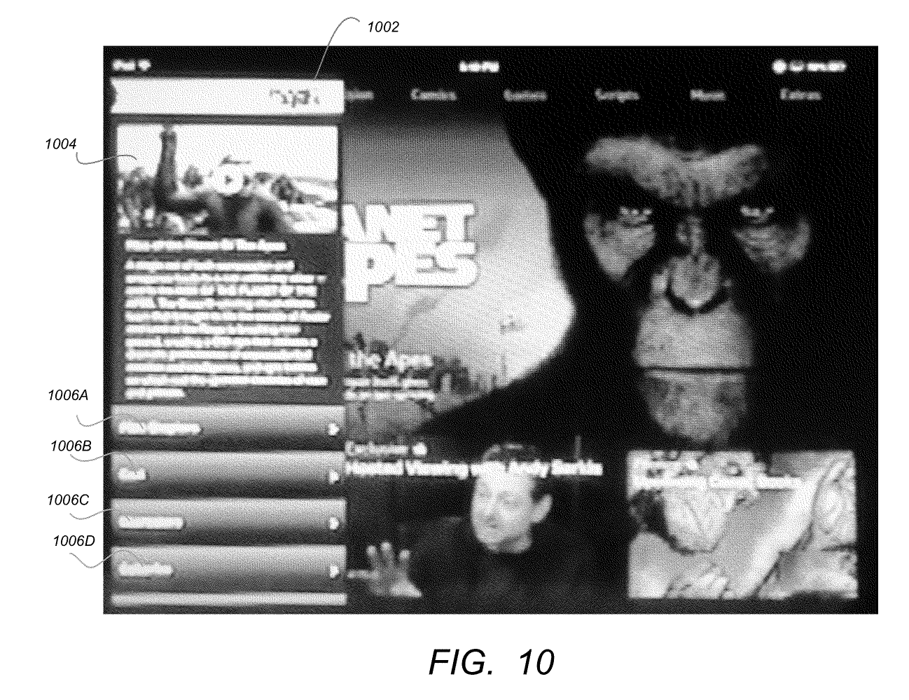

FIG. 10 is a diagram illustrating how secondary assets related to the currently selected primary asset 404 can be directly accessed. Selection of one of the controls 902A-902G and swiping right presents interface 1002, which includes a highlight of the primary asset 404 along with a description, as well as other control elements 1006A-1006D to explore secondary assets related to the highlighted primary asset 404.

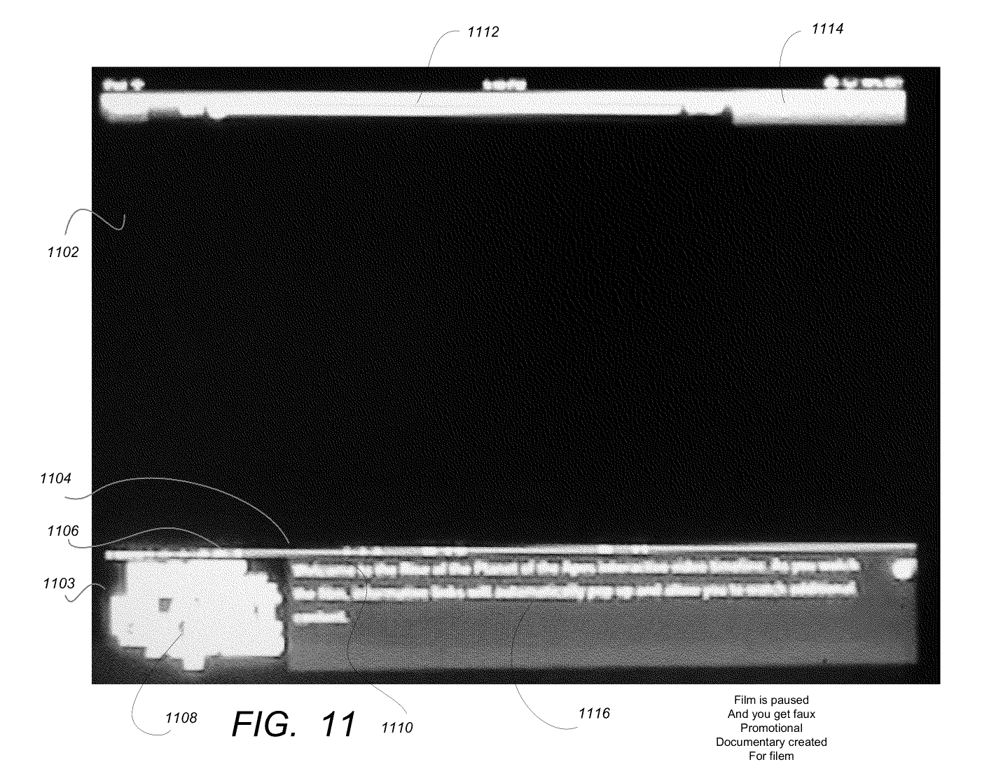

FIG. 11 is a diagram illustrating the presentation of the primary asset. In this embodiment, a primary asset or movie has been selected via any of the foregoing means, and the theater widget 204A presents the feature film in one (as illustrated, the to top) portion 1102 of the display, while the feed widget 204B presents a means to navigate the related auxiliary content or secondary asset in a context appropriate and temporally relevant way in a bottom portion 1103. In the illustrated embodiment, the secondary asset segment 506S representations generated by the feed widget 204B are presented in a time line 1104, having the representations 1106 located in a position proportional to their temporal location of relevance to the associated primary asset or movie. Optionally, the representations can show the temporal length of the portion of the primary asset for which the secondary asset segments is relevant by their length (for example, using temporal indexing of the primary asset that includes both the beginning and end of the indexes to the segment). User selection of these representations pauses playback of the primary asset and initiates the presentation of the secondary asset segment or element related to the selected representation 1106. Other embodiments are possible. For example, while the top portion 1102 of the display presents a progress bar 1112 to illustrate and control playback of the primary asset using the media player 112, and navigation controls 1114 separately (as they are presented by the native OS), the timeline 1104 may be combined with the progress bar 1112, or presented adjacent one another.

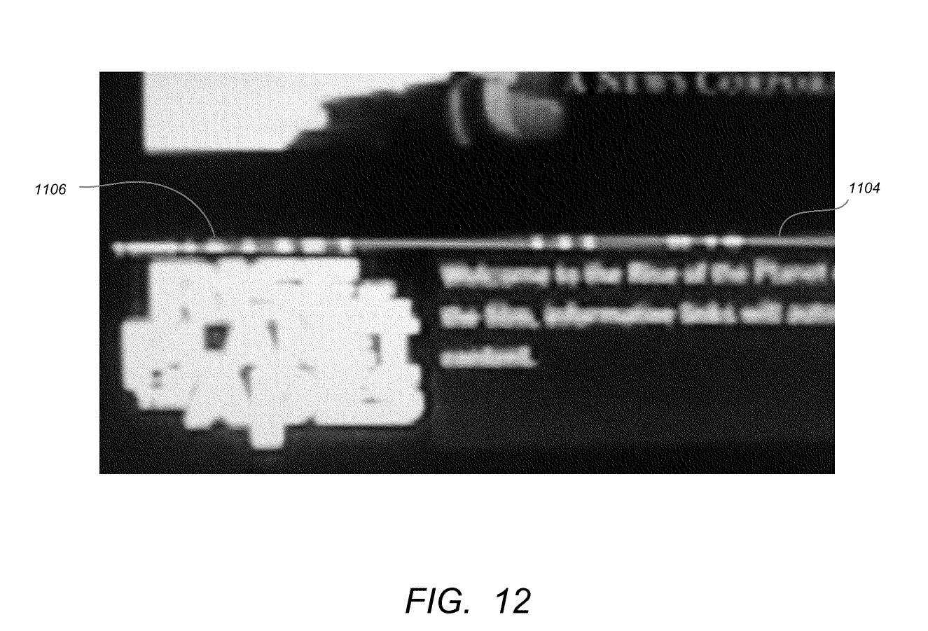

FIG. 12 is an enlarged view of the presented representations 1106 of the secondary asset on the timeline 1104.

FIG. 11 also illustrates that the second feed portion 1103 also includes an image portion 1108 and text portion 1110 that changes as the primary asset is played so as to present information relevant to that currently played portion of the primary asset. The images and the text change as the playback of the primary asset proceeds. The text presented in text portion 1110 is also identified in the asset index 512 and linked to secondary assets so that portions of the text are highlighted to indicate that selection of the highlighted text will cause the feed widget 204B to pause playback of the primary asset and navigate to the secondary asset associated with the content of that highlighted text, if necessary, invoking another widget 204 to accomplish this.

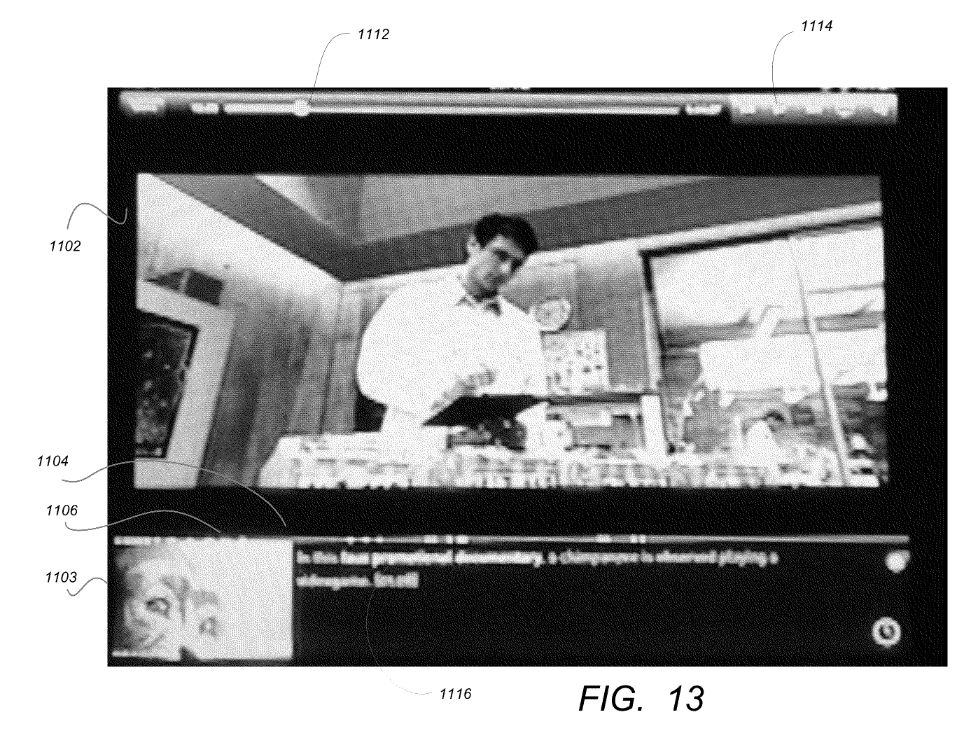

FIG. 13 is a diagram illustrating the user interface at a point temporally occurring during the playback of the primary asset of movie. While the movie plays, the temporal location of the current movie location moves along the progress bar 1112 and/or the timeline 1104, and when the location corresponds to an element of auxiliary content, a message is presented in the feed widget's 204B portion of the screen 1103 about the auxiliary content. In one example, the Planet of the Apes includes a scene wherein a chimpanzee is shown attempting to solve a puzzle. The auxiliary media content may include a documentary about chimp cognitive ability, thus showing information about the documentary in the feed, while the Planet of the Apes plays concurrently in the theater portion 1102 of the display. Text portion 1110 includes highlighted text 1116 providing a link to that documentary.

Each of the representations 1106 (as illustrated, bands) a portion or segment of the primary asset (featured media program) played by the theatrical feed at the temporal location indicated in the timeline 1104. The user may navigate not only to any location within the featured media program by manipulating a control on the progress bar 112, they may jump to the auxiliary content by selecting the band 1106 of interest, or by dragging the band 1106 to the appropriate location on the progress bar 1112. Note also, the native controls 1114 for playing the media program on the uppermost portion of the screen. The user may then play the secondary asset (documentary) instead of the media program by selecting the feed portion of the screen or a control included therein. In another embodiment, the secondary asset can be presented concurrently with the primary asset, with the audio from one of the assets muted as necessary.

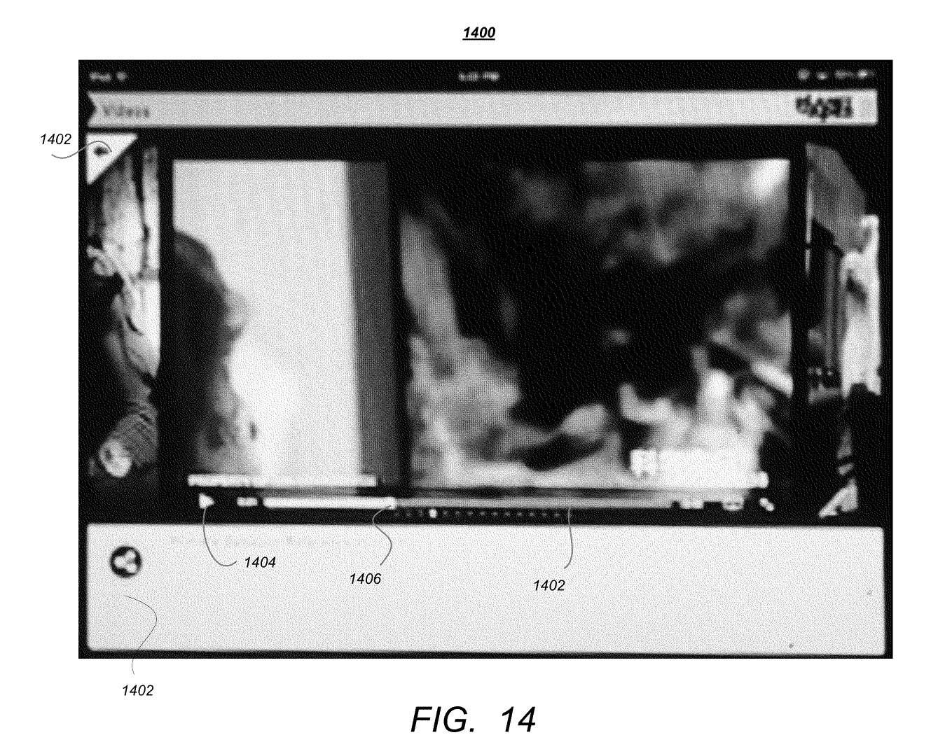

FIG. 14 is a diagram illustrating a user interface 1400 shown based upon selection of one of the representations 1106 or highlighted text 1116 for playback of the secondary asset. Since the secondary asset is a video of a documentary, the playback interface 1400 includes another progress bar 1402 and playback control(s) 1404-1406, and a control 1408 to return playback to the primary asset. Also provided is a share control 1402, which allows an aspect of the secondary content or the secondary content itself to be shared via a social network.

Playback of the primary asset by the theater widget 204A may be paused while the secondary asset is being provided. It is also possible to have multiple hierarchical levels of auxiliary content. In other words, a timeline analogous to timeline 1104 may be used with the secondary asset that can be used to navigate back to the primary asset (e.g. perhaps the featured media program is referenced by the documentary) or to media content that itself is a secondary asset documentary, or to another of the secondary assets, for example using navigation path 428 of FIG. 4. This allows browsing of a wide variety of media content in an intuitive way while viewing other media content.

It is also possible to organize the auxiliary media content by topic as well as by temporal location of the relevant portion of the featured media program. For example, the progress bar may present bands with different colors (or other such differentiation), each relating to a different category of content (video games, documentaries, etc.) that are relevant to that portion of the media program. The user may also select that they are only interested in one category of auxiliary content, allowing the user to thin down the number of bands presented. Alternatively, multiple progress bars may be presented.

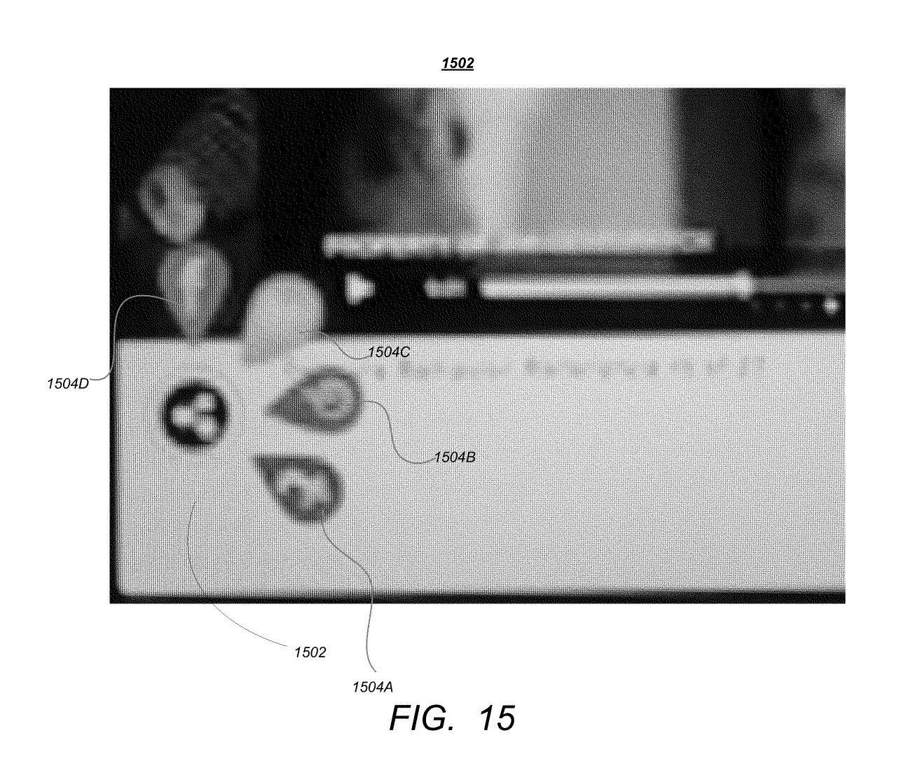

FIG. 15 is a diagram illustrating an exemplary embodiment of an interface 1500 having a control flower 1502 provided after selection of the share control 1402. The control flower 1502 includes petals 1504A-1504D, the selection of which permits the user to “share” the subject matter presented on the interface 1500 with others on the related social network, or to enter a commercial utility that allows the user to purchase an item or service related to the subject matter presented on the interface 1500.

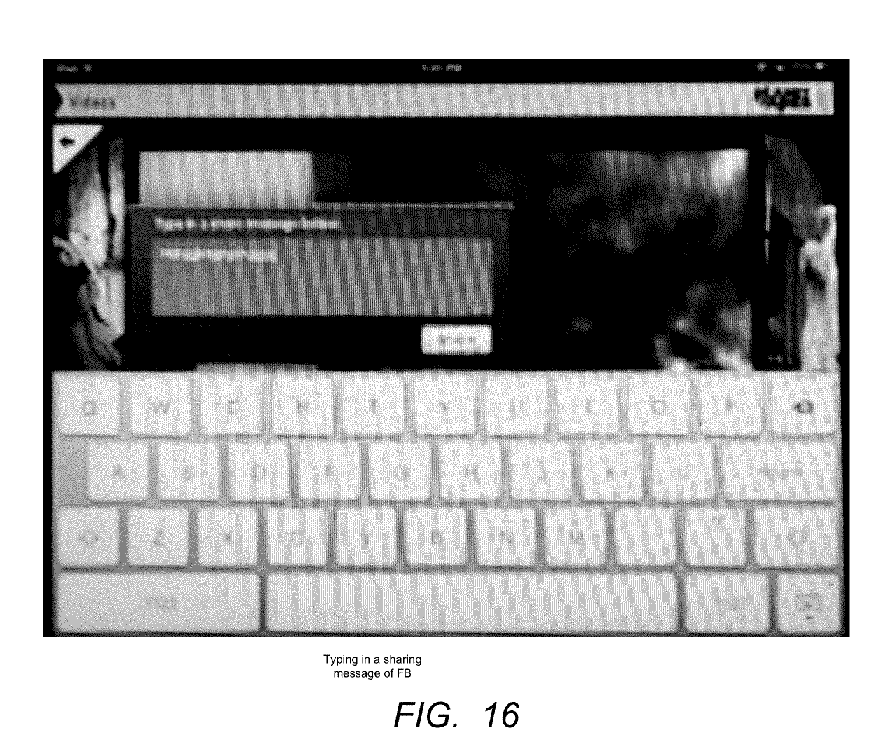

FIG. 16 is a diagram illustrating an exemplary embodiment of an interface 1600 presented upon selection of a social network petal 1504 of the control flower 1502. An input window 1602 is presented, allowing the user to enter text using keyboard 1604 and selecting the share control 1604. For example, the user may have selected a FACEBOOK social network petal 1504 of the control flower, opening the above interface and allowing the user to share that they are watching the documentary, or make comments on the documentary.

Note that although the foregoing indicates an embodiment where the viewing of the primary asset 404 is the jumping off place for the second content (e.g. the hub of a wheel, with the other content being the spokes of the wheel accessed by the appropriate widget), this need not be the case. The primary asset 404 may instead be accessed from an interface from a secondary asset associated with another primary asset 404 (e.g. from secondary asset 418 to primary asset 404C, as shown in FIG. 4).

Other media content and widgets for playing them can include books, scripts, and screenplays, by selection of the appropriate control (which may include representations 1106, one of controls 802-814, or asset browser 816).

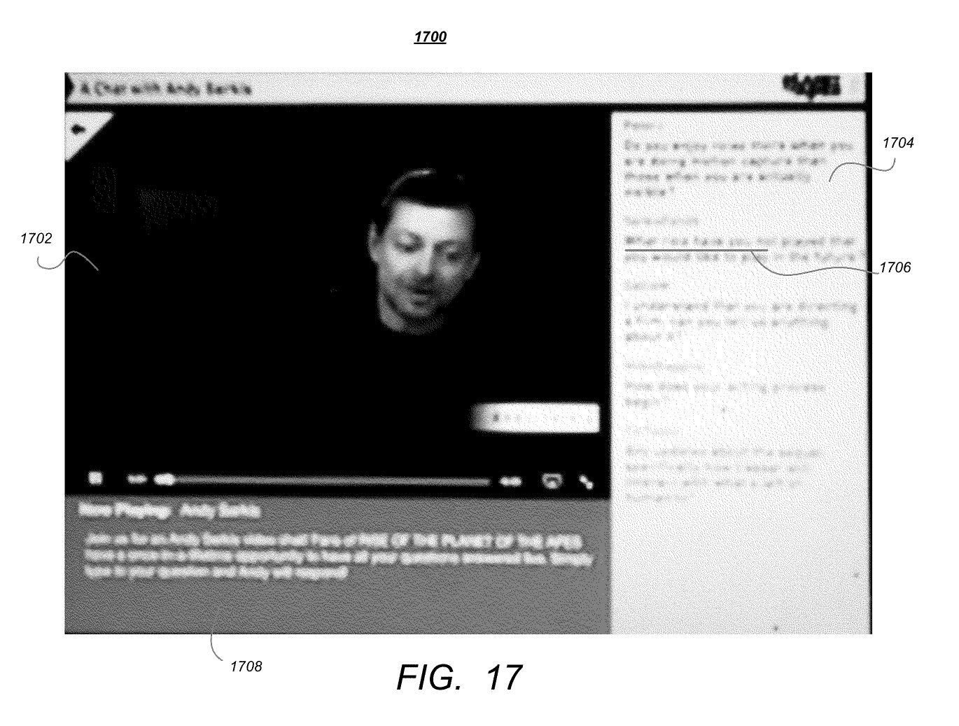

FIG. 17 is a diagram illustrating a user interface 1700 a secondary asset that comprises a video of an interview of the director of the primary asset. The secondary asset is presented in a first portion 1702 of the user interface 1700, which is may be implemented by the media player 112 of the OS 110 or a dedicated media player associated or integrated with the widget 240 used to present the secondary asset. A second portion 1704 can present the text of the interview, with highlighted text 1706 providing a link to another secondary access via another widget 240. Hence, secondary assets can be hierarchically layered. For example, in FIG. 4, secondary asset 424C can be used to access further secondary asset 432 via widget 430. A third portion 1708 describes the secondary asset presented in the interface 1700 and the text itself may include hyperlinks to other secondary assets as well.

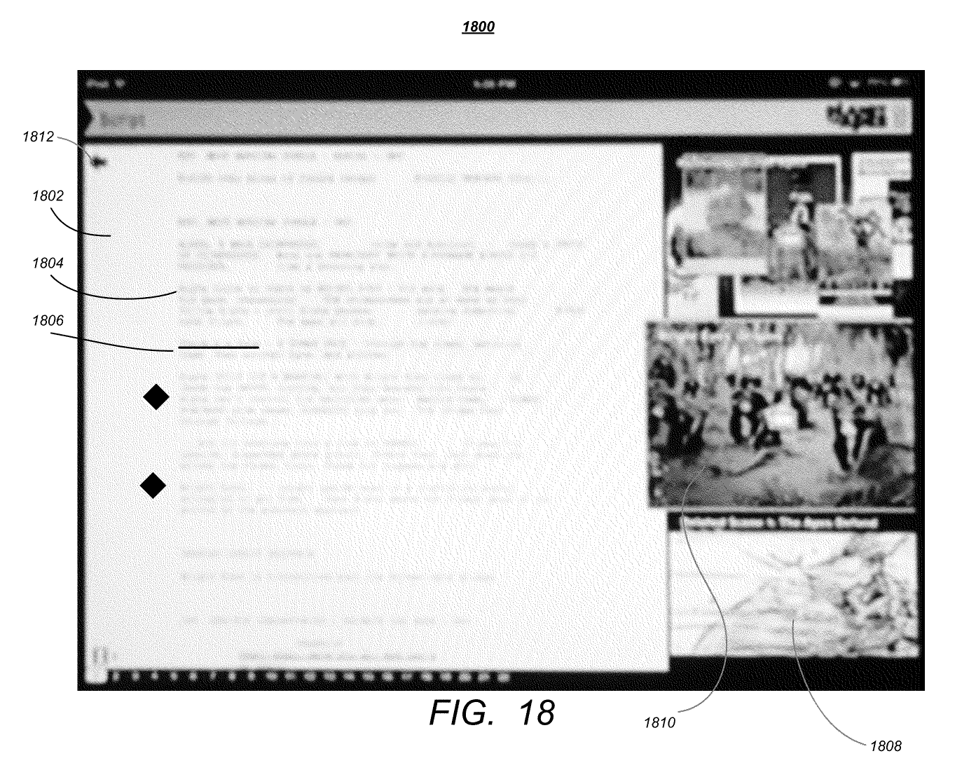

FIG. 18 is a diagram of the user interface 1800 produced by a script widget 240. This can be presented in response to user selection of a representation or band 1106 associated with a script, or via selection of the script control 810. The result is a presentation of the script or screenplay related to the primary asset. The script widget 240 is used to present the screenplay on in a first portion 1802 and visual showing related material in a second portion 1808.

In this embodiment, as the user scrolls through the script in portion 1802 (for example, by use of a scroll bar or by swiping the content itself up or down), secondary assets having auxiliary content relevant to that portion of the script is presented in the second portion 1808 of the interface 1800. The auxiliary content may be provided by secondary assets that might include comics, video games, or any of the other relevant secondary assets. Or, the user may scroll through the second portion 1808 (e.g. by swiping gestures) and this will move the presentation of the script to the first portion 1802 to a point relevant to the information displayed in the second portion 1808. Selecting one of the portions 1802, 1808 depicting the secondary content may bring the user to the auxiliary content for viewing or other consumption. In this way, the user may quickly browse through all secondary assets related to the primary asset. Also noteworthy is that this is an example of linking the primary content to the secondary content in a context other than a temporal context.

The screenplay may also include highlighted links 1806, which may be underlining of text or annotations. Selecting the highlighted text may bring the user to that point in the primary asset for playback by the theater widget 204A, thus making the screenplay or script the hub and the feature film, the spoke, instead of the configuration shown in FIG. 4, where the primary assets 404 take on the role of the hub. Further, selecting other highlighted text may bring the user to other related auxiliary media, such as another movie.

This paradigm can be used with the other widgets and content. For example, consider the comic content replayed by the motion comic widget described above. Selecting a link in the comic presented by the motion comic widget may bring the user to the related point in the movie (and of course, as already described, selecting the band associated with the comic may bring a user watching the movie to the analogous location in the comic.

### Other Media Assets and Widgets

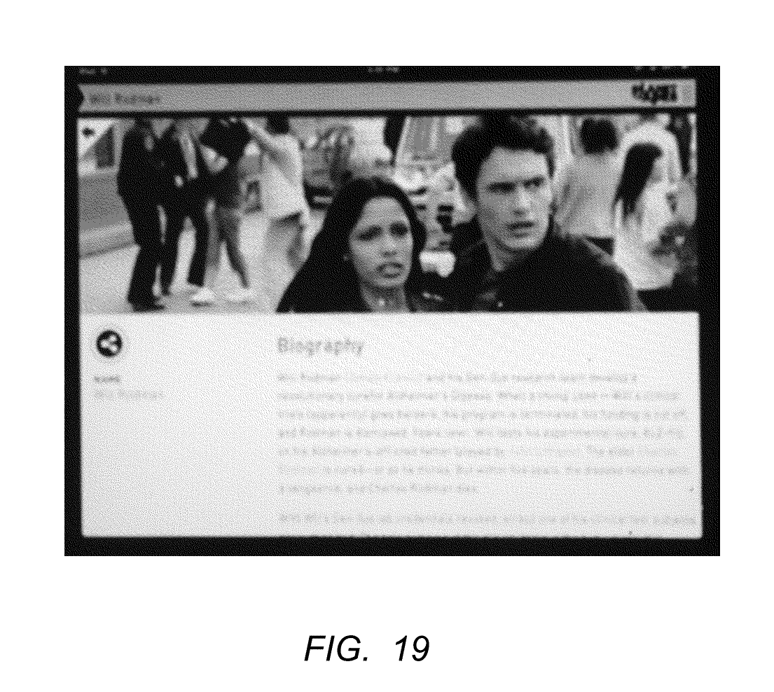

As described above, the widgets can include curated media rich presentations such as those directed at particular characters or actors. FIG. 19 shows one embodiment of how a dossier widget can render video, audio, image, text, or any of the other media.

The dossier widget's presentation of the related media can be invoked by a link presented by any other of the widgets, and the data presented therein may include links to other information auxiliary to the dossier (for example, a feature film in which the subject of the dossier (the actor or the character) is depicted. For example, going back to the Planet of the Apes example, a dossier may be presented using the dossier widget for the character “Caesar” (the first ape to say ‘no’), and links within the dossier may take the user to the point in the movie (or any of the movies) where the character either first appears, or when they say “no.”

Other media may include information such as a link to the location where the movie was filmed. For example, a link may b presented (in the movie itself using the theatre widget) to a location within Malibu State Park, if that is where that portion of the movie was filmed.

### Distribution

Content may be distributed by means of tangible devices such as optical discs or via electronic distribution, for example, the Internet. Such distribution can be directly from the content publisher, or a retailer. Such content may be usable in a broad variety of devices including desktop computers, laptops, tablet computers, smartphones, and smart televisions. Importantly, the paradigm described below allows any or all of these devices to be enabled by provision of the optical disc or electronic file.

Media, widgets and utilities can be distributed by electronic and/or physical retailers, or through publishers. The media can be distributed electronically in files, or distributed in tangible media such as optical discs or flash memory.

Initially, franchises 400 may be released as a standalone application, and a player shell included with the initial content download, with the auxiliary media content visible using native library applications (e.g. special features, available from a DVD menu). Widget and utility applications may be included in the distributed medium to implement the features above using devices capable of presenting this information, while devices which are not capable present the information as an ordinary optical disc player would do so.

As the product evolves, the a single “shell” application that can be used with multiple franchises are developed, and new franchises may be issued within this model. In the media term, as the paradigm becomes more widely accepted and integrated into commercial CE devices, the widget and utility functionality needed to implement some of the functionality may be included in the native devices

### Accommodation of Different Device Functional Capabilities

As described above, in prior distribution paradigms (e.g. DVD and Blu-ray disks), all of the hardware was essentially the same I terms of basic functionality). However, newer distribution paradigms must account for different devices and operating systems of different capabilities and capacities. The CDCP is flexible to address the requirement to deliver auxiliary content that is based upon the device that is using it, and allows for the content and even the device itself to be remotely updated over time to alter capabilities. In this paradigm, some of the required functionality is provided on the distributed medium (e.g. the optical disk) and some is provided from a remote cloud using data on the disk (e.g. security related data, media, widgets, or utilities). Hence, the “content” may be distributed on a device as simple as a magnetic card or electronically transmitted data.

To permit the user experience to be consistent and flexible across a wide variety of devices, the distributed information includes rights, functionality, and a bundle of keys with a bundle of rights that can be used to unlock a bundle of functionality. Which functionality is unlocked may depend upon device capabilities. Such device capabilities may include the digital rights management (DRM) capabilities, computing power, memory, throughput, or architectural factors. For example, a particular device may be certified as having sufficient security (whether though software, hardware, or the system architecture) to permit one level of functionality, but not another. For example some devices include open boot loaders, which expose them to possible compromise. It may be advisable to allow only low resolution content to be decoded and presented on such devices. Another example is that some devices do not have the computational capacity to present high definition video, and an attempt to do so will result in a substandard viewing experience. Preventing such a device from attempting to present the content in high definition form will not only present user frustration, it may also give the content provider a bad reputation in the eyes of that particular consumer, who may believe the fault lies with the content provider, not the device.

The foregoing can be implemented by certifying devices for different rights and different functionality (e.g. by manufacturers or independent parties), with such devices identified by software versions or hardware versions. Self certification may also be performed, by running standard widgets against standard media or by similar test to determine memory, processing capacity and throughput and the natively supported functional features of the device. It is also possible to use manufacturer and self certification to enhance security. For example, if the device is tested to have capabilities significantly different than any device in its class, it may be determined that the identity of the device itself is questionable and has been tampered with. Accordingly, a taxonomy of many different attributes of capability may be defined, by industry, by company, by content, by industry standard specifications or individual company specifications.

### Security

As described above, one of the difficulties with the consumption of media content on digital devices is how that can be enabled without also enabling the unauthorized use or proliferation of unauthorized copies of the media content. The CDCP 200 solves this problem by presenting a framework in which the media assets 202, widgets 204 (and appurtenant services), and utilities 206 and/or the glue (e.g. the asset map 512) that allows them to operate together can be split between the processor device 102 a remote entity in the cloud.

This is accomplished by distinguishing between service components and content components, and making service components (e.g. the widgets 204 or the asset map 512) an indispensable part of the presentation of the content components (e.g. the media assets 202). By placing some of the essential elements needed for consumption at a secure site remote from the consumer, the content provider retains more control over the content consumption experience and when it is provided. For example, an optical disc may have all the necessary elements to play a primary asset such as a feature film, but the assembly of those elements may be remotely orchestrated by a remote server using, for example, the asset map 512. Since this orchestration may not require much in the way of data throughput, such control may be effected with little bandwidth and significant latency. This can be used to prevent unauthorized users from gaining access to the content for playback purposes.

This may also be applied to auxiliary content. For example one of the utilities discussed above permits the user to request a “viewing party” wherein they can control the presentation of a media program with friends. In one embodiment, although the viewing party may be in part implemented by an associated widget, the system can be configured such that a remote server must start and maintain the viewing party, by synchronizing the video streams to multiple locations. However, if the person in possession of the underlying content (the optical disc) is not an authorized user (e.g. the disc was pirated), the user will not be identified as a legitimate owner, and the remote server would refuse to provide the service. As much of the value in the optical disc is derived from the ability to use such services, the value in pirating the optical disc itself is compromised.

The use of service components also permits the provision of further media content types. For example, a viewing group may comprise a plurality of film students having a live question and answer session with a cinematographer or director via the interface shown in FIG. 17. The right to view this live broadcast may be provided as a part of the bundle of rights granted to the possessor of the optical disc. Even if the live Q&A video is recorded and unauthorized copies are made and disseminated, such copies will not provide the same media consuming experience, as they will be without the ability to connect that content to auxiliary content. For example, if the Q&A is with a cinematographer and the cinematographer mentions how a particular scene was shot, the connection between the Q&A media and the movie itself is implemented on the remote server, and not the device itself. Since the remote server is providing the information used to link the Q&A to the media content, only those with authorized copies will be able to view the Q&A with the linking feature enabled.

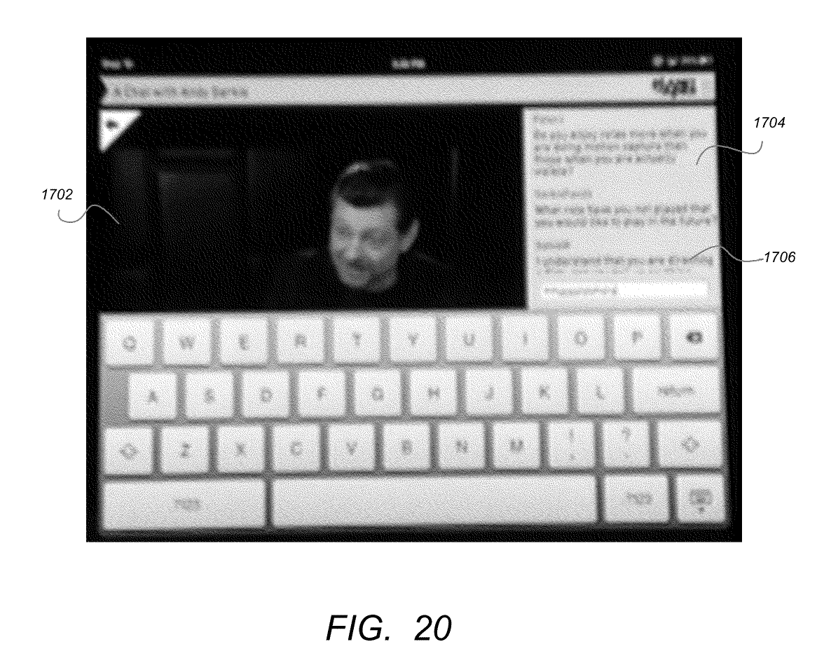

FIG. 20 illustrates a user interface 2000 for a Q&A session permitting event, by which the user may ask a question by typing it into input box 1706 using the interface shown, and submit it for consideration and answer by the interviewee. Or the entered information may just be shown to other viewers for comments. In this case, second portion 1704 may be implemented by a utility 206 rather than a widget 204.

### Hardware Environment

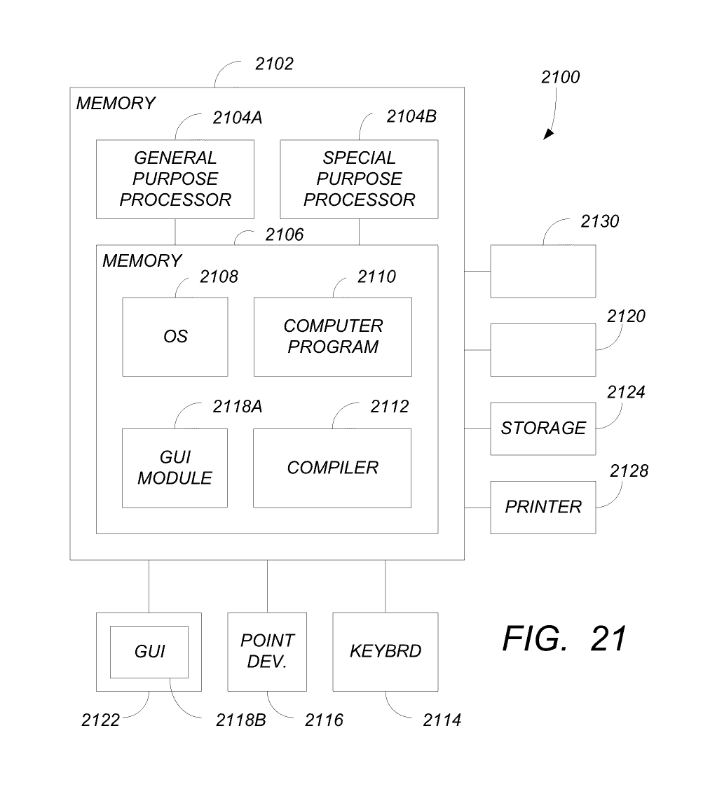

FIG. 21 is a diagram illustrating an exemplary computer system 2100 that could be used to implement elements of the present invention, including the processing device 102 and remote servers. The computer 2102 comprises a general purpose hardware processor 2104A and/or a special purpose hardware processor 2104B (hereinafter alternatively collectively referred to as processor 2104) and a memory 2106, such as random access memory (RAM). The computer 2102 may be coupled to other devices, including input/output (I/O) devices such as a keyboard 2114, a mouse device 2116 and a printer 2128.

In one embodiment, the computer 2102 operates by the general purpose processor 2104A performing instructions defined by the computer program 2110 under control of an operating system 2108. The computer program 2110 and/or the operating system 2108 may be stored in the memory 2106 and may interface with the user and/or other devices to accept input and commands and, based on such input and commands and the instructions defined by the computer program 2110 and operating system 2108 to provide output and results.

Output/results may be presented on the display 2122 or provided to another device for presentation or further processing or action. In one embodiment, the display 2122 comprises a liquid crystal display (LCD) having a plurality of separately addressable pixels formed by liquid crystals. Each pixel of the display 2122 changes to an opaque or translucent state to form a part of the image on the display in response to the data or information generated by the processor 2104 from the application of the instructions of the computer program 2110 and/or operating system 2108 to the input and commands. Other display 2122 types also include picture elements that change state in order to create the image presented on the display 2122. The image may be provided through a graphical user interface (GUI) module 2118A. Although the GUI module 2118A is depicted as a separate module, the instructions performing the GUI functions can be resident or distributed in the operating system 2108, the computer program 2110, or implemented with special purpose memory and processors.

Some or all of the operations performed by the computer 2102 according to the computer program 2110 instructions may be implemented in a special purpose processor 2104B. In this embodiment, some or all of the computer program 2110 instructions may be implemented via firmware instructions stored in a read only memory (ROM), a programmable read only memory (PROM) or flash memory within the special purpose processor 2104B or in memory 2106. The special purpose processor 2104B may also be hardwired through circuit design to perform some or all of the operations to implement the present invention. Further, the special purpose processor 2104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 2102 may also implement a compiler 2112 which allows an application program 2110 written in a programming language such as COBOL, C++, FORTRAN, or other language to be translated into processor 2104 readable code. After completion, the application or computer program 2110 accesses and manipulates data accepted from I/O devices and stored in the memory 2106 of the computer 2102 using the relationships and logic that was generated using the compiler 2112.

The computer 2102 also optionally comprises an external communication device such as a modem, satellite link, Ethernet card, or other device for accepting input from and providing output to other computers.

In one embodiment, instructions implementing the operating system 2108, the computer program 2110, and/or the compiler 2112 are tangibly embodied in a computer-readable medium, e.g., data storage device 2120, which could include one or more fixed or removable data storage devices, such as a zip drive, floppy disc drive 2124, hard drive, CD-ROM drive, tape drive, or a flash drive. Further, the operating system 2108 and the computer program 2110 are comprised of computer program instructions which, when accessed, read and executed by the computer 2102, causes the computer 2102 to perform the steps necessary to implement and/or use the present invention or to load the program of instructions into a memory, thus creating a special purpose data structure causing the computer to operate as a specially programmed computer executing the method steps described herein. Computer program 2110 and/or operating instructions may also be tangibly embodied in memory 2106 and/or data communications devices 2130, thereby making a computer program product or article of manufacture according to the invention. As such, the terms “article of manufacture,” “program storage device” and “computer program product” or “computer readable storage device” as used herein are intended to encompass a computer program accessible from any computer readable device or media.

Of course, those skilled in the art will recognize that any combination of the above components, or any number of different components, peripherals, and other devices, may be used with the computer 2102.

Although the term “computer” is referred to herein, it is understood that the computer may include portable devices such as cellphones, portable MP3 players, video game consoles, notebook computers, pocket computers, or any other device with suitable processing, communication, and input/output capability.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of distributing content comprising at least a portion of a primary media asset having a plurality of primary media asset segments, and at least a portion of a secondary media asset having a plurality of secondary media asset segments, comprising the steps of:
receiving information from a media program provider, the information readable by a processing device and comprising:
the at least a portion of the primary media asset segments;
a primary media asset index to at least some of the plurality of primary media asset segments;
at least two widgets, comprising further instructions executed by the processor, comprising;
a theater widget; and
a feed widget;
retrieving, using the processor executing the theater widget, the plurality of primary media asset segments;
providing, using the processor executing the theater widget, the plurality of primary media asset segments for presentation by a media player native to the processor according to an asset map having the primary media asset index;
generating, using the processor executing the theater widget, a representation of each of the secondary media asset segments from a primary media asset index to at least some of the plurality of primary media asset segments according to the asset map, the representation of each secondary media asset segment for presentation concurrently and in context with the presentation of the plurality of primary media asset segments;
retrieving and providing, using the feed widget and the asset map, a second media asset segment for presentation according to a user selection of the representation associated with the secondary media asset-segment.

2. The method of claim 1, wherein:
all of the primary media asset segments is embodied in a tangible media; and
all of the plurality of primary media asset segments are retrieved from the media.

3. The method of claim 2, wherein the second media asset segments are retrieved from a remote server

4. The method of claim 1, wherein
only a portion of the primary media asset segments is embodied in a tangible media; and
the portion of the plurality of media asset segments are retrieved from the tangible media and a remainder of the plurality of media asset segments are retrieved from a remote server.

5. The method of claim 1, wherein:
all of the primary media asset segments is embodied in a tangible media; and
the asset map is accessed only via the remote server.

6. The method of claim 1, further comprising:
transmitting, using the theater widget, a primary media asset playback request to a remote server, wherein the request comprises processor information and primary media asset playback rights information; and
receiving primary media asset playback information for playing back only primary media asset segments selected according to the processor information and the playback rights information.

7. The method of claim 6, wherein the primary media asset segments are encrypted so as to be decryptable according to one or more decryption keys and the primary media asset playback information comprises the one or more decryption keys.

8. The method of claim 6, wherein the playback information further comprises the primary media asset index, and the theater widget retrieves the primary media asset segments according to the primary media asset index and provides the primary media assets for playback by the media player native to the processor.

9. The method of claim 1, further comprising:
transmitting, using the feed widget, a secondary media asset playback request to a remote server, wherein the request comprises processor information and secondary media asset playback rights information;
receiving secondary media asset playback information for playing back only secondary media asset segments selected according to the processor information and the rights information;

10. The method of claim 9, wherein the secondary media asset segments are encrypted so as to be decryptable according to one or more decryption keys and the secondary media asset playback information comprises the one or more decryption keys.

11. The method of claim 9, wherein the secondary playback information further comprises the secondary media asset index, and the feed widget retrieves the secondary media asset segments according to the secondary media asset index and provides the primary media assets for playback by the media player native to the processor.

12. The method of claim 1, wherein:
the primary media asset comprises a plurality of triggering events identified by the primary media asset index;
the presentation of the second media asset segment is unlocked and performed only on a condition that at least one of triggering events identified by the primary media asset index has occurred.

13. The method of claim 12, above, wherein:
the at least one of the triggering events comprises viewing an associated primary media asset segment.

14. The method of claim 1, wherein:
the secondary media asset comprises a plurality of triggering events identified by the secondary media asset index;
the providing of at least one of the plurality of primary media asset segments for presentation by the media player is unlocked and performed only on a condition that at least one of the triggering events identified by the secondary media asset index has occurred.

15. The method of claim 14, above, wherein:
the at least one of the triggering events comprises viewing an associated primary media asset segment.

16. An apparatus for distributing content comprising at least a portion of a primary media asset having a plurality of primary media asset segments, and at least a portion of a secondary media asset having a plurality of secondary media asset segments, comprising:
a processor; and
a memory, communicatively coupled to the processor, the memory storing instructions commanding the processor, the instructions comprising instructions for:
receiving information from a media program provider, the information readable by a processing device and comprising:
the at least a portion of the primary media asset segments;
a primary media asset index to at least some of the plurality of primary media asset segments;
at least two widgets, implemented by further instructions executable by the processor, comprising;
a theater widget; and
a feed widget;
retrieving, using the processor executing the theater widget, the plurality of primary media asset segments;
providing, using the processor executing the theater widget, the plurality of primary media asset segments for presentation by a media player native to the processor according to an asset map having the primary media asset index;
generating, using the processor executing the theater widget, a representation of each of the secondary media asset segments from a primary media asset index to at least some of the plurality of primary media asset segments according to the asset map, the representation of each secondary media asset segment for presentation concurrently and in context with the presentation of the plurality of primary media asset segments;
retrieving and providing, using the feed widget and the asset map, a second media asset segment for presentation according to a user selection of the representation associated with the secondary media asset-segment.

17. The apparatus of claim 16, wherein:
the primary media asset comprises a plurality of triggering events identified by the primary media asset index;
the presentation of the second media asset segment is unlocked and performed only on a condition that at least one of triggering events identified by the primary media asset index has occurred.

18. The apparatus of claim 17, above, wherein:
the at least one of the triggering events comprises viewing an associated primary media asset segment.

19. The apparatus of claim 16, wherein:
the secondary media asset comprises a plurality of triggering events identified by the secondary media asset index;
the providing of at least one of the plurality of primary media asset segments for presentation by the media player is unlocked and performed only on a condition that at least one of the triggering events identified by the secondary media asset index has occurred.

20. The apparatus of claim 19, above, wherein:
the at least one of the triggering events comprises viewing an associated primary media asset segment.

21. A system for distributing content comprising at least a portion of a primary media asset having a plurality of primary media asset segments, and at least a portion of a secondary media asset having a plurality of secondary media asset segments, comprising:
a processor; and
a tangible memory, communicatively coupled to the processor, the tangible memory storing processor instructions including instructions for:
receiving information, the information comprising:
the at least a portion of the primary media asset segments;
a primary media asset index to at least some of the plurality of primary media asset segments;
at least two widgets, each widget comprising associated widget instructions executable by the processor, the widgets comprising;
a theater widget; and
a feed widget;
retrieving, using the processor executing the theater widget, the plurality of primary media asset segments;
providing, using the processor executing the theater widget, the plurality of primary media asset segments for presentation by a media player native to the processor according to an asset map having the primary media asset index;
generating, using the processor executing the theater widget, a representation of each of the secondary media asset segments from a primary media asset index to at least some of the plurality of primary media asset segments according to the asset map, the representation of each secondary media asset segment for presentation concurrently and in context with the presentation of the plurality of primary media asset segments; and
retrieving and providing, using the feed widget and the asset map, a second media asset segment for presentation according to a user selection of the representation associated with the secondary media asset-segment.
